(19) United States
(12) Patent Application Publication
(10) Pub. No.: US 2020/0384897 A1
(43) Pub. Date: Dec. 10, 2020

(54) DEVICE FOR A VEHICLE SEAT WITH A ROTATION UNIT AND A SLIDING UNIT

(71) Applicant: Aguti Produktentwicklung & Design GmbH, Langenargen (DE)

(72) Inventor: Christian ROGG, Wasserburg (DE)

(73) Assignee: Aguti Produktentwicklung & Design GmbH, Langenargen (DE)

(21) Appl. No.: 16/432,056

(22) Filed: Jun. 5, 2019

(51) Int. Cl. B60N 2/14; B60N 2/08

(52) U.S. Cl. CPC B60N 2/146; B60N 2/08

(57) ABSTRACT

A device for a vehicle seat with a rotation unit and a sliding unit, wherein different rotation positions of the rotation unit are adjustable, wherein different sliding positions of the sliding unit are adjustable. The device is characterized in that the device comprises an interlock mechanism, so that an adjustability of a rotation range of the rotation unit is dependent upon a sliding position of the sliding unit.

### FIELD OF THE INVENTION

The present invention relates to a device for a vehicle seat with a rotation unit and a sliding unit.

### BACKGROUND OF THE INVENTION

Devices for the movement of a vehicle seat are already known.

One known device for the movement of a vehicle seat is designed as a rotation unit, by means of which the vehicle seat can rotate about an axis of rotation perpendicular to a sitting surface of the vehicle seat. Another known device for the movement of the vehicle seat is designed as a sliding mechanism, by means of which the vehicle seat can slide along a sliding direction. Combinations of the two aforementioned movement device variants are also known, whereby the vehicle seat can both be rotated about an axis of rotation and displaced in a sliding direction, while the sliding direction is advantageously designed perpendicular to the axis of rotation.

The drawback to such a device combination is that a vehicle seat on which this device combination is mounted requires a relatively large space or range of movement in the vehicle in which the vehicle seat can be mounted.

### SUMMARY OF THE INVENTION

The problem which the present invention proposes to solve is to provide an improved device for the moving of a vehicle seat of a vehicle.

The present invention starts from a device for a vehicle seat with a rotation unit and a sliding unit, wherein different rotation positions of the rotation unit are adjustable, wherein different sliding positions of the sliding unit are adjustable. The device is present, for example, as a vehicle seat device.

A vehicle in which the vehicle seat is advantageously mountable is, for example, designed as an automobile, e.g., a van, a mobile home, a camper, and/or a caravan. However, it is also conceivable for the vehicle to be designed as a trailer or a residential trailer.

The vehicle seat may be present as a driver or a passenger seat and it may be mounted, in particular, in a front region of the vehicle. It is also conceivable for the vehicle seat to be mounted in a rear region of the vehicle. The vehicle seat can be designed, for example, as a single seat.

The essential aspect of the present invention is seen to be that the device comprises an interlock mechanism, so that an adjustability of a rotation range of the rotation unit is dependent upon a sliding position of the sliding unit.

In one advantageous variant of the device, the device comprises an interlock mechanism, so that an adjustability of a sliding range of the sliding unit is dependent upon a rotation position of the rotation unit.

Thanks to both of the aforementioned variants of the present invention, a spatial range can be adjusted that can be adopted by the vehicle seat containing the device. In particular, it is possible to dictate in this way a rotating and/or shifting range or a movement range of the device, especially the vehicle seat on which the device is present.

It is also of advantage that one degree of freedom of a movement of the rotation unit and/or the sliding unit is bounded or limited by the interlock mechanism.

Advantageously, a rotation range is defined in dependence on a sliding position of the sliding unit, e.g., a rotation of the rotation unit is prevented by the interlock mechanism depending on a sliding position of the sliding unit. The rotation range, which can be set, is preferably less than a full turn, for example, less than 360°. Advantageously, several rotation ranges are present on the rotation unit, which can be set by a sliding position of the sliding unit. For example, a rotation range can be set between 0° and 360°, such as between 0° and 180° or between 0° and 90°. It is conceivable for a rotation range of 5°, 10°, 15°, 20°, 25°, 30°, 35°, 40°, 45°, 50°, 55°, 60°, 75° or 90° to be definable.

The sliding unit is linearly slidable, in particular. Preferably a sliding range is defined in dependence on a rotation position of the rotation unit, e.g., a sliding of the sliding unit is prevented by the interlock mechanism in dependence on a rotation position of the rotation unit. For example, several sliding ranges are present on the sliding unit, which can be set by a rotation position of the rotation unit. For example, a sliding range can be set which is less than half the maximum sliding length of the sliding unit. It is conceivable that the sliding range can be defined in such a way that it is less than or equal to one quarter of the maximum sliding length of the sliding unit, for example.

It is further proposed that the interlock mechanism comprises a locking element, wherein the locking element is slidable and/or pivotable perpendicular to an axis of rotation of the rotation unit.

Advantageously, the locking element comprises a longitudinal axis. The locking element is oriented e.g. with the longitudinal axis parallel to the axis of rotation of the rotation unit. The locking element is in the shape of a pin, for example, it being designed for instance as a bolt and/or a screw. Preferably the locking element is mounted on the rotation unit, e.g., fastened in a slidable and/or rotatable manner on the rotation unit.

It is also advantageous that latching mechanism is present on the rotation unit, the latching mechanism being present in such a way that the locking element can engage with the latching mechanism, and upon engaging of the locking element with the latching mechanism a rotation range of the rotation unit is limited. Advantageously, the interlock mechanism comprises the latching mechanism. By one advantageous embodiment of the latching mechanism, a rotation range is dictated, for example, upon engaging of the locking element with the latching mechanism.

One advantageous modification of the present invention is that holding mechanism is present on the sliding unit, the holding mechanism being present in such a way that the locking element can engage with the holding mechanism, and upon engaging of the locking element with the holding mechanism a sliding range of the sliding unit is limited. For example, the interlock mechanism comprises the holding mechanism. By one advantageous embodiment of the holding mechanism, a sliding range is dictated, for example, upon engaging of the locking element with the holding mechanism.

It is also proposed that the locking element is present in such a way that the locking element engages either with the latching mechanism and/or with the holding mechanism. It is conceivable that the locking element engages either with the latching mechanism or the holding mechanism. But it is also conceivable that the locking element engages with both the holding mechanism and with the latching mechanism, in particular, at the same time. It is conceivable that the holding mechanism and the latching mechanism are configured such that the locking element can engage with both at the same time, in which case the device in this condition is both slidable and rotatable, especially at the same time.

It is likewise advantageous that the interlock mechanism comprises an operating element, which is connected to the locking element in such a way that a position of the locking element is changeable by a movement of the operating element.

The operating element is configured as a lever, for example. In this way, it is possible for a user to employ the operating lever to change the position of the locking element. Advantageously, the operating element and the locking element are present as a single piece. It is conceivable that the operating element is L-shaped or T-shaped, where one short side of the L, for example, is configured as the locking element and/or the short side of the L comprises the locking element, for example.

It is further proposed that, in the mounted condition of the device on the vehicle, the latching mechanism is present on the rotation unit in fixed position relative to the vehicle. Advantageously, the latching mechanism is present on the rotation unit in fixed position.

The rotation unit is configured as a two-piece part, for example, wherein the two pieces of the rotation unit can turn relative to each other. A first piece of the rotation unit is advantageously configured as a base plate, which is provided to be joined, in particular, in fixed position to the vehicle in the mounted condition. Preferably, the latching mechanism is formed on the base plate. A second piece is configured as a turntable, for example. The turntable is designed, e.g., to mount the sliding unit. In this way, the sliding unit is advantageously mounted slidably on the rotation unit relative to the latching mechanism. The operating element and/or the locking element is arranged on the turntable, for example.

It also proves to be advantageous that the holding mechanism is present on the sliding unit slideably relative to the rotation unit.

The sliding unit is preferably likewise two-piece. A first sliding piece is connected, in particular, fixed in position to the turntable, for example. A second sliding piece is advantageously present on the sliding unit, slidable with respect to the first sliding piece, especially in linear movement.

Advantageously, the holding mechanism is present on the sliding unit slideably relative to the rotation unit, in particular, slidable to the latching mechanism and/or slidable to the locking element, for example. Preferably the holding mechanism is formed on the second sliding piece. It is also conceivable for the operating lever and/or the locking element to be mounted on the first sliding piece.

It is also conceivable for the turntable and the first sliding piece to be present as a single piece.

It is likewise advantageous for the device to comprise a guide element, which is designed to guide the locking element. For example, the guide element is present in such a way that a movement or a movement range of the locking element is limited. It is also conceivable for the guide element to be configured in such a way that the guide element dictates a movement plane of the locking element. The guide element is advantageously formed on the turntable and/or on the first sliding piece.

### BRIEF DESCRIPTION OF THE DRAWINGS

An exemplary embodiment shall be explained more closely with the aid of the following schematic drawings, indicating further details and advantages.

FIG. 1 is a perspective diagonal front view from above of a device according to the present invention;

FIG. 2 is a top view of the device of FIG. 1;

FIG. 3 is a perspective diagonal front view from above of the device of FIG. 1 with a sliding unit in an altered position;

FIG. 4 is an enlarged representation in a further perspective view of a locking element of the device in a position of the device per FIG. 3;

FIGS. 5 to 8 are perspective diagonal front views from above of the device of FIG. 1 with the sliding unit and a rotation unit in different, altered position;

and

FIG. 9 is an enlarged representation in a further perspective view of the locking element of the device in a position as per FIG. 7 or 8 with the sliding unit in a further position.

### DETAILED DESCRIPTION OF THE INVENTION

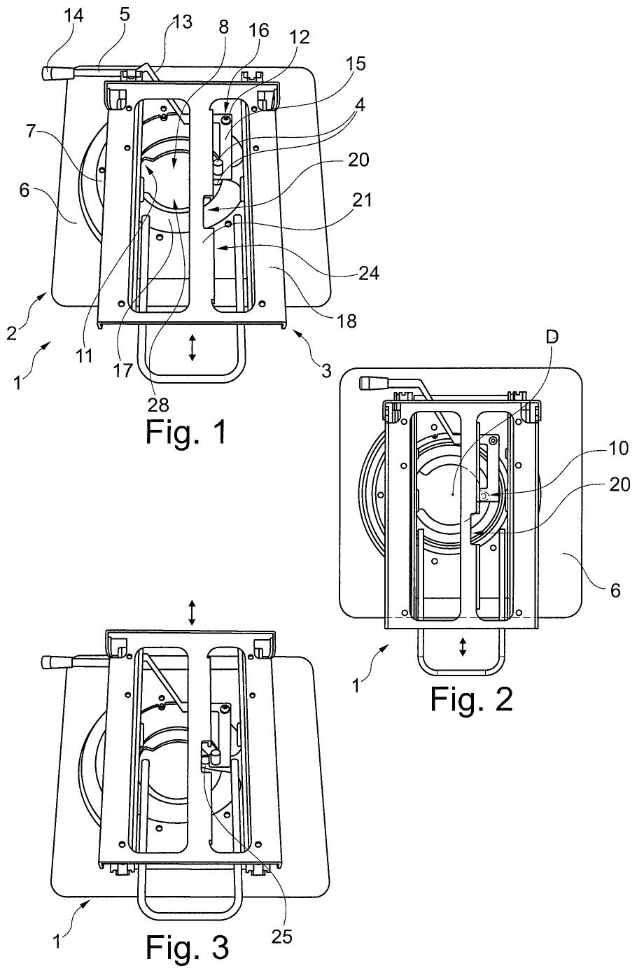

A device 1 according to the present invention comprises a rotation unit 2, a sliding unit 3, a locking element 4, as well as an operating lever 5, for example, (FIGS. 1 to 9).

The rotation unit 2 is advantageously composed of a base plate 6 and a turntable 7. The base plate 6 is configured, for example, to be fixed in position and mounted on a vehicle (not shown), e.g., on a substructure of a vehicle seat. The turntable 7 is mounted on the base plate 6, for example, rotatable about an axis of rotation D. The base plate 6 has, for example, a circular opening 8, especially a cylindrical one, in an area around the axis of rotation D. The turntable 7 has, for example, a circular opening 28, especially a cylindrical one, in an area around the axis of rotation D. Advantageously, a diameter of the opening 28 is as large as or larger than a diameter of the opening 8. The base plate 8 advantageously borders the opening 8 with a peripheral edge 9, such as a circular one, especially a cylindrical one. In the area of the peripheral edge 9, latching mechanism is formed on the base plate 8 in the form of cut-outs 10, 11. The cut-outs 10, 11 are advantageously present in such a way that they interrupt the circular and/or cylindrical contour of the peripheral edge 9, for example, or increase its diameter.

For example, the operating lever 5 is rotatably or pivotably mounted on the turntable 7 on a mount 12 of the turntable 7. The operating lever 5 is advantageously angled in configuration, with a, for example, relatively long lever arm 13, on which a handle 14 is present for working the operating lever 5 by the user, and a, for example, relatively short lever arm 15 making an angle with this. Advantageously the locking element 4 is formed on the lever arm 15. The two lever arms 13, 15 are preferably joined together at a connection point 16. For example, the operating lever 5 is mounted on the mount 12 at the connection point 16, especially in rotatable manner.

The sliding unit 3 has, for example, a first sliding piece 17 and a second sliding piece 18.

Advantageously, the first and the second sliding piece 17, 18 are slidable relative to each other, especially in linear manner, on the sliding unit 3. Preferably the first sliding piece 17 is firmly joined to the turntable 7 of the rotation unit 2, e.g., screwed, welded, and/or riveted. In this way, the sliding unit 3 can rotate relative to the base plate 6. In particular, in the mounted condition of the device 1 on the vehicle, the sliding unit 3 is in this way rotatably mounted on the vehicle.

The first sliding piece 17 advantageously comprises, for example, a circular, in particular, cylindrical opening 19. The opening 19 especially in one diameter is precisely as large, advantageously larger in configuration than the opening 8 of the rotation unit 2. It is also conceivable that the first sliding piece 17 is framelike, while distances between mutually facing sides of the frame are advantageously larger than the diameter of the openings 8, 28 of the rotation unit 2 and the sliding unit 3 is mounted on the rotation unit 2 in such a way that the frame of the first sliding piece 17, looking from a top view onto the device 1, is not present above the openings 8, 19 or the frame sides are present at a distance from the peripheral edge 9 toward the outside in the radial direction. It is further conceivable that the first sliding piece 17 comprises two rail elements 22, 23, on which the second sliding piece 18 is arranged, especially in a linearly slidable manner. Advantageously, the two rail elements 22, 23 are oriented parallel to each other. The two rail elements 22, 23 are advantageously spaced apart from each other in such a way that the spacing of the rail elements 22, 23 is larger than a largest diameter of an opening 8, 19.

The second sliding piece 18 advantageously comprises a mounting device, on which a vehicle seat (not shown) can be secured. In the mounted condition, the vehicle seat and the second sliding piece 18 are advantageously joined together in fixed position. In this way, for example, a vehicle seat is connected both rotatably and displaceably to the base plate 6 or to a vehicle.

The second sliding piece 18 is likewise advantageously framelike. Ideally, a frame of the second sliding piece 18 corresponds in its dimensions to dimensions of the frame of the first sliding piece 17. For example, the second sliding piece 18 comprises in addition a lengthwise brace 21. The lengthwise brace 21 is configured, for example, in such a way and the sliding unit 3 is advantageously arranged on the rotation unit 2 in such a way that the lengthwise brace 21, especially in every position of the device 1, forms a secant to the two openings 8, 19. For example, the lengthwise brace 21 is present on the sliding unit 3 parallel to the rail elements 22, 23 of the first sliding piece 17 and is formed, for example, between sides of the frame of the second sliding piece 18. On the second sliding piece 18, a holding mechanism is present, for example, in the form of a cut-out 20 in the region of the edge 24 on the lengthwise brace 21.

Advantageously, in every displacement or rotation position of the device 1, an edge 24 of the lengthwise brace 21 looking in a top view onto the device 1 forms a tangent to the opening 8 or a tangent to a circular arc of the opening 8, especially a tangent to the peripheral edge 9 of the opening 8. Preferably, looking in a top view, one point of the edge 24 of the lengthwise brace 21 and one point of a longitudinal axis of the lengthwise brace 21 situated on a normal to the edge 24 or the longitudinal axis of the lengthwise brace 21, the normals extending through the axis of rotation D, are present at the same spacing in every rotational or sliding position of the device 1 with respect to the peripheral edge 9 of the base plate 6 or the circular arc of the opening 8 of the base plate 6, this spacing being called hereafter the radial spacing. Advantageously, this radial spacing from the edge 24 to the peripheral edge 9 of the base plate 6 is zero, i.e., looking from the top view onto the device 1, the edge 24 or the lengthwise brace 21 is tangent to the peripheral edge 9 or the circular arc of the opening 8, for example.

Advantageously, both the latching mechanism and the holding mechanism are present in such a way that the locking element 4 can be positioned to engage with the latching mechanism or the holding mechanism, so that the locking element 4 looking in a top view onto the device 1 is not intersected by the circular arc of the opening 8 or the longitudinal axis of the edge 24 of the lengthwise brace 21.

The locking element 4 is formed, in particular, as a cylindrical bolt, for example. The bolt is advantageously arranged on the operating lever 5 in such a way that a longitudinal axis of the bolt is present perpendicular to a plane of movement of the operating lever 5. For example, the bolt in every position on the device 1 engages either with a latching mechanism, e.g., with the cut-out 10 or with the cut-out 11, and/or with a holding mechanism, e.g., with the cut-out 20.

Advantageously, the bolt is present such that it can be arranged to abut by a first outer region in the mounted condition against the latching mechanism or against a surface of the latching mechanism and it can be arranged to abut by a second outer region, which is present opposite the first outer region in the radial direction looking toward the axis of rotation D, against the holding mechanism or against a surface of the holding mechanism.

If the bolt engages in one position with a holding mechanism, a rotation range of the turntable 7 relative to the base plate 6 will be limited. Conversely, if the bolt engages in one position with a latching mechanism, a displacement range of the second sliding piece 18 relative to the first sliding piece 17 or to the base plate 6 will be limited. If the device is present, e.g., in such a way that the bolt engages in one position with both a latching mechanism and a holding mechanism at the same time, both a rotation range and a displacement range will be limited.

In the following, various movement positions of the device 1 will be described as an example with FIGS. 1 to 9.

In FIGS. 1 and 2, the bolt is situated engaging with the cut-out 10. In this way, a rotational movement of the turntable 7 and thus of the sliding unit 3 relative to the base plate 6 is blocked. In this position, the cut-out 10 surrounds the bolt advantageously with form fitting, such that the bolt is hindered by the cut-out 10 in a rotating direction about the axis of rotation D (FIG. 2). FIG. 2 shows the sliding unit 2 transparent relative to the base plate 6 in a top view onto the device 1, for better comprehension. In this way, it can be seen that the turntable 7 is secured by the bolt in the cut-out 10 relative to the base plate 6 and that the second sliding piece 18 of the sliding unit 3 can move slidably past the bolt.

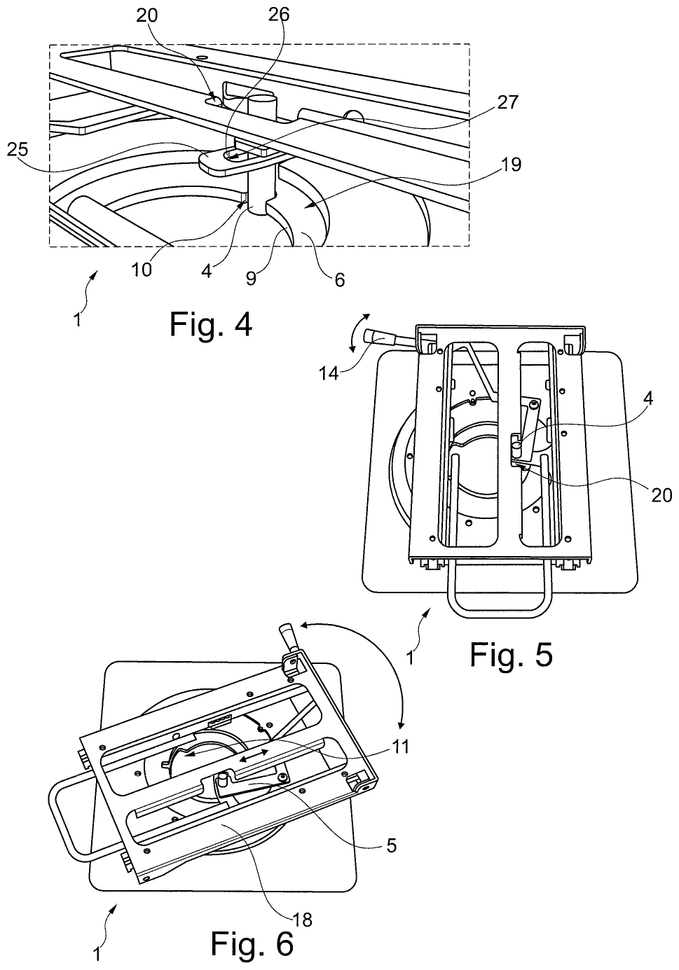

In FIGS. 3 and 5, the second sliding piece 18 has been displaced relative to the base plate 6 in such a way that the bolt can be pivoted into the cut-out 20 by a movement of the operating lever 5. FIG. 4 in addition shows that the bolt is led advantageously by a guide element in the form of a guide plate 25. For this, the guide plate 25 comprises e.g. a slotlike cut-out 26, in which the bolt is led along the pivoting movement dictated by the operating lever 5. The cut-out 26 advantageously has a stop surface 27, against which the bolt abuts in the maximum pivoted condition. This prevents a skewing or jamming of the device 1 or the operating lever 5.

If the bolt has been pivoted into the cut-out 20 (FIG. 6), the second sliding piece 18 can be displaced along the lengthwise brace 21, relative to the base plate 6, according to the size of the cut-out 20, especially according to the length of the cut-out 20. For this, the cut-out 20 has e.g. two mutually facing end stops, against which the bolt abuts when the second sliding piece 18 is moved by a user. This defines a sliding range of the sliding unit 3. At the same time, a rotation of the turntable 7 relative to the base plate 6 is free, so that the sliding unit 3 and thus, for example, the mounted vehicle seat can rotate relative to the base plate 6.

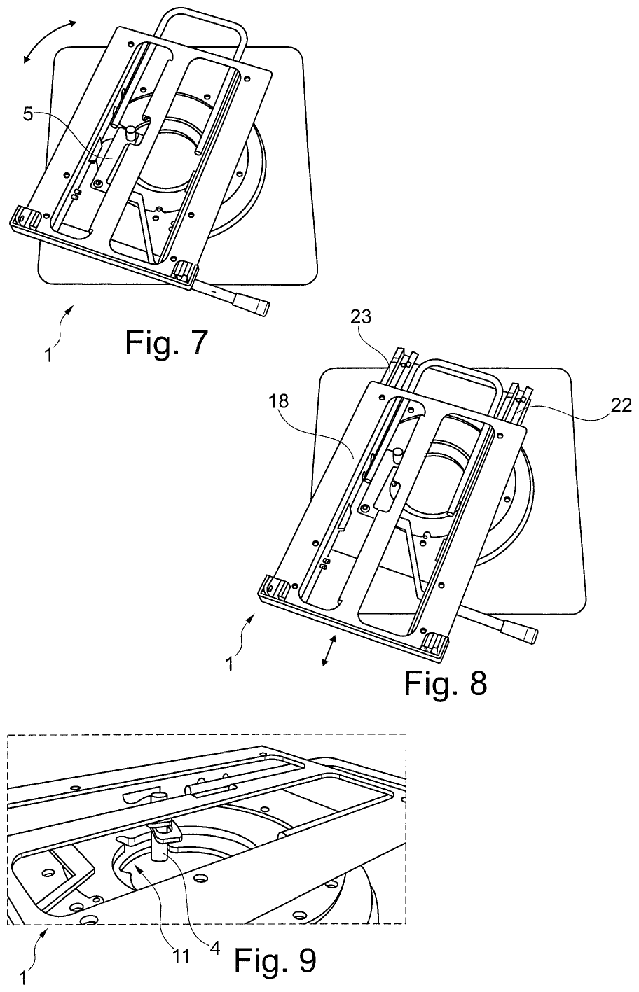

FIG. 7 shows how the sliding unit 3 has been rotated relative to the base plate 6 such that the cut-out 20 and the cut-out 11 are adjacent to each other. In this way, the operating lever 5 can be pivoted, so that the bolt can be pivoted out from the cut-out 20 of the second sliding unit 18 into the cut-out 11 of the base plate 6.

In the movement position of the bolt in the cut-out 11, the sliding unit 3 is once again freely movable relative to the base plate 6 (FIGS. 8, 9), while a rotation range of the turntable 7 relative to the base plate 6 is limited by the cut-out 11.

### LIST OF REFERENCE NUMBERS

1 Device
2 Rotation unit
3 Sliding unit
4 Locking element
5 Operating lever
6 Base plate
7 Turntable
8, 19, 28 Opening
9 Peripheral edge
10, 11 Cut-out
12 Mount
13, 15 Lever arm
14 Handle
16 Connection point
17, 18 Sliding piece
20 Cut-out
21 Lengthwise brace
22, 23 Rail element
24 Edge
25 Guide plate
26 Cut-out
27 Stop surface

1. A device for a vehicle seat with a rotation unit and a sliding unit, wherein different rotation positions of the rotation unit are adjustable, and wherein different sliding positions of the sliding unit are adjustable,
wherein the device comprises an interlock mechanism, so that an adjustability of a rotation range of the rotation unit is dependent upon a sliding position of the sliding unit.

2. The device for a vehicle seat according to claim 1,
wherein the device comprises an interlock mechanism, so that an adjustability of a sliding range of the sliding unit is dependent upon a rotation position of the rotation unit.

3. The device for a vehicle seat according to claim 2, wherein the interlock mechanism comprises a locking element, wherein the locking element is slidable or pivotable perpendicular to an axis of rotation D of the rotation unit.

4. The device for a vehicle seat according to claim 3, further comprising a latching mechanism present on the rotation unit, the latching mechanism being present in such a way that the locking element can engage with the latching mechanism, and upon engaging of the locking element with the latching mechanism a rotation range of the rotation unit is limited.

5. The device for a vehicle seat according to claim 3, further comprising a holding mechanism present on the sliding unit, the holding mechanism being present in such a way that the locking element can engage with the holding mechanism, and upon engaging of the locking element with the holding mechanism a sliding range of the sliding unit is limited.

6. The device for a vehicle seat according to claim 3, wherein the locking element is present in such a way that the locking element engages either with the latching mechanism.

7. The device for a vehicle seat according to claim 3, wherein the interlock mechanism comprises an operating element, which is connected to the locking element in such a way that a position of the locking element is changeable by a movement of the operating element.

8. The device for a vehicle seat according to claim 4, wherein in the mounted condition of the device on the vehicle, the latching mechanism is present on the rotation unit in fixed position relative to the vehicle.

9. The device for a vehicle seat according to claim 5, wherein the holding mechanism is present on the sliding unit slideably relative to the rotation unit.

10. The device for a vehicle seat according to claim 3, further comprising a guide element, designed to guide the locking element.

11. A vehicle seat with a device according to claim 1.

12. A vehicle with a vehicle seat according to claim 1.

13. The device for a vehicle seat according to claim 4, wherein the locking element engages with the holding mechanism.

14. A device for a vehicle seat with a rotation unit and a sliding unit, wherein different rotation positions of the rotation unit are adjustable, and wherein different sliding positions of the sliding unit are adjustable,
wherein the device comprises an interlock mechanism, so that an adjustability of a sliding range of the sliding unit is dependent upon a rotation position of the rotation unit.
